(19) United States
(12) Patent Application Publication
(10) Pub. No.: US 2007/0186714 A1
(43) Pub. Date: Aug. 16, 2007

(54) Bicycle cable connection arrangement

(75) Inventor: Tatsuya Kawakami, Osaka (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/351,261

(22) Filed: Feb. 10, 2006

(51) Int. Cl. F16C 1/10

(52) U.S. Cl. 74/502.2

(57) ABSTRACT

A bicycle cable connection arrangement is provided that comprises a wire takeup member, and a cable end attachment member. The wire takeup member includes a cable attachment retaining structure. The cable end attachment member includes a cable receiving structure and a mating mounting structure that is configured and arranged to be retained to the cable attachment retaining structure of the wire takeup member in a first orientation and to be releasable from the cable attachment retaining structure of the wire takeup member in a second orientation.

### BACKGROUND OF THE INVENTION

1. Field of the Invention

This invention generally relates to a bicycle cable connection arrangement. More specifically, the present invention relates to a bicycle cable connection arrangement for attaching an inner wire of a cable to a wire take-up member of a bicycle component such as a bicycle shift control device.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. In particular, control devices for braking and/or shifting have been extensively redesigned in recent years.

Currently, there are many types of cable operated shifting devices or shifters currently being installed on bicycles. For example, some cable operated shifting devices have a pair of shift levers and a cable winding mechanism that rotates via a ratchet mechanism. Some conventional cable operated shifting devices of this type are configured such that the shift lever can be moved to cause a cable wire winder type of a wire takeup member to rotate via the ratchet mechanism in one direction by one or more gears at a time. As a result, the cable is wound around a peripheral surface of the cable wire winder (takeup member), and a shift is made by the shift mechanism from one gear to another gear. Operation of the other shift lever causes the ratchet mechanism to be released and the cable wire winder to rotate in the other direction by one or more gears at a time. As a result, the cable that was wound on the cable wire winder is played out, and a shift is made in the opposite direction by the shift mechanism. One example of a bicycle shift control device or shifter with a cable winder type of a wire takeup member is disclosed in U.S. Pat. No. 6,694,840 (assigned to Shimano, Inc.).

Other cable operated shifting devices or shifters use a wire takeup member that does not wind the inner wire around a peripheral surface of the takeup member. One example of a bicycle shift control device or shifter with this type of a wire takeup member is disclosed in U.S. Pat. No. 6,647,823 (assigned to Shimano, Inc.). In this shifter, the takeup member is not cable winder, but cable pulling member and it has a hook. This cable pulling member type of a wire takeup member is superior to cable winder in efficiency because there is no friction between the inner wire and the wire groove. In the cable pulling member, a relatively large cable hook and a pivot pin are used to pivotally attach the inner wire. However, the cable pulling member type of a wire takeup member also has some disadvantages relative to the cable winder type of a wire takeup member. For example, the cable pulling member type of a wire takeup member requires more parts than the cable winder type of a wire takeup member. This can increase manufacturing process and costs.

In view of the above, it will be apparent to those skilled in the art from this disclosure that there exists a need for an improved bicycle cable connection arrangement. This invention addresses this need in the art as well as other needs, which will become apparent to those skilled in the art from this disclosure.

### SUMMARY OF THE INVENTION

One object of the present invention is to provide a bicycle cable connection arrangement that is relatively simple to manufacture and assemble.

Another object of the present invention is to provide a bicycle cable connection arrangement that has relatively few parts.

Another object of the present invention is to provide a bicycle cable connection arrangement that is relatively inexpensive to produce.

Another object of the present invention is to provide a bicycle shift control device that is relatively simple and inexpensive to manufacture and assemble.

The foregoing objects can basically be attained by providing a bicycle cable connection arrangement is provided that basically comprises a wire takeup member, and a cable end attachment member. The wire takeup member includes a cable attachment retaining structure. The cable end attachment member includes a cable receiving structure and a mating mounting structure that is configured and arranged to be retained to the cable attachment retaining structure of the wire takeup member in a first orientation and to be releasable from the cable attachment retaining structure of the wire takeup member in a second orientation.

These and other objects, features, aspects and advantages of the present invention will become apparent to those skilled in the art from the following detailed descriptions, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a bicycle having front and rear shift operating devices with bicycle cable connection arrangements in accordance with a preferred embodiment of the present invention;

FIG. 2 is an enlarged perspective view of the left shift operating device in accordance with the present invention;

FIG. 3 is an exploded perspective view of the left shift operating device illustrated in FIG. 2;

FIG. 4 is a diagrammatic sequence of enlarged partial perspective views of the bicycle cable connection arrangement showing a portion of the wire takeup member and the cable end attachment member coupled to the inner wire of the shift cable;

FIG. 5 is a diagrammatic sequence of partial top plan views of the cable end attachment member being attached to the portion of the wire takeup member illustrated in FIG. 4 in accordance with the present invention;

FIG. 6 is a diagrammatic sequence of partial side elevational views of the cable end attachment member being attached to the portion of the wire takeup member illustrated in FIG. 4 in accordance with the present invention;

FIG. 7 is a top plan view of the wire takeup member of the left shift operating device in accordance with the present invention;

FIG. 8 is a bottom plan view of the wire takeup member of the left shift operating device in accordance with the present invention;

FIG. 9 is a first edge elevational view of the wire takeup member of the left shift operating device in accordance with the present invention;

FIG. 10 is a second edge elevational view of the wire takeup member of the left shift operating device in accordance with the present invention;

FIG. 11 is a first side elevational view of the cable end attachment member in accordance with the present invention;

FIG. 12 is a second side elevational view of the cable end attachment member in accordance with the present invention;

FIG. 13 is a third side elevational view of the cable end attachment member in accordance with the present invention;

FIG. 14 is a bottom plan view of the cable end attachment member in accordance with the present invention;

FIG. 15 is a cross-sectional view of the cable end attachment member illustrated in FIGS. 11-14 as seen along section line 15-15 of FIG. 11;

FIG. 16 is a cross-sectional view of the cable end attachment member illustrated in FIGS. 11-14 as seen along section line 16-16 of FIG. 12;

FIG. 17 is a cross-sectional view of the cable end attachment member illustrated in FIGS. 11-14 as seen along section line 17-17 of FIG. 12; and

FIG. 18 is a cross-sectional view of the cable end attachment member illustrated in FIGS. 11-14 as seen along section line 17-17 of FIG. 13.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

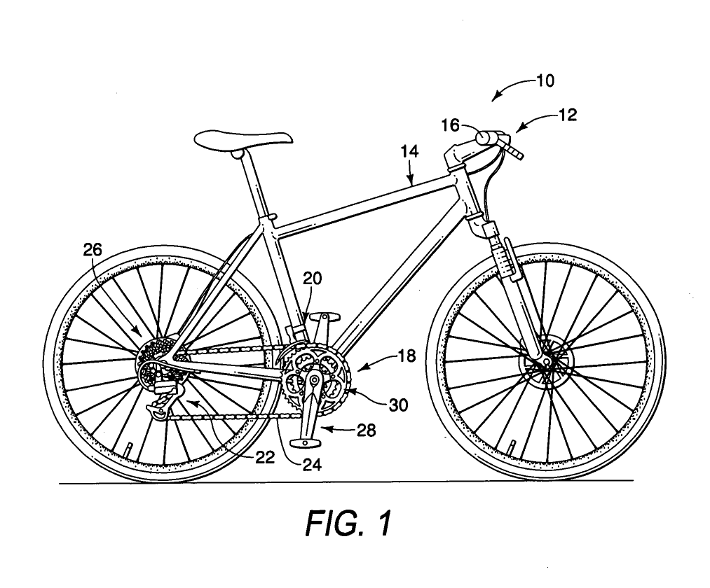

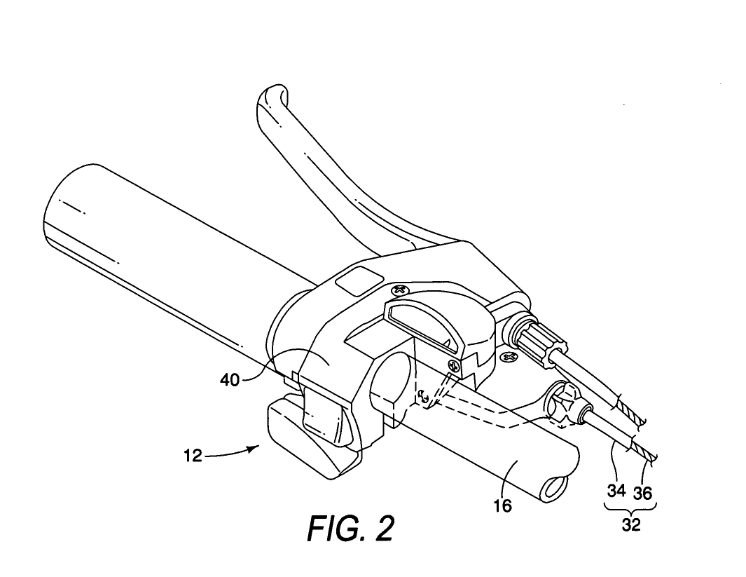

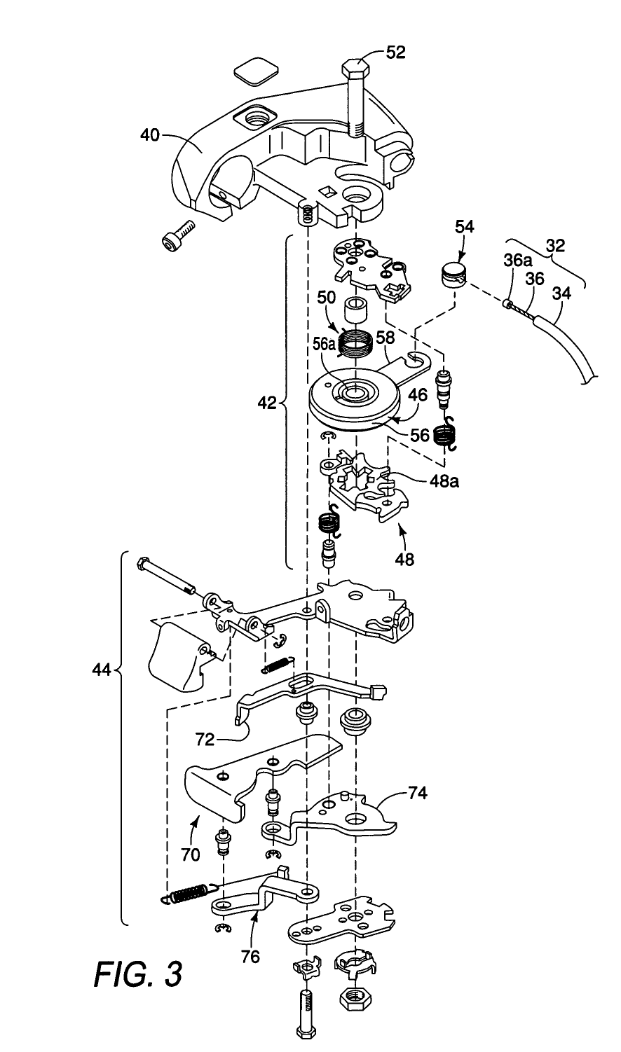

Referring initially to FIGS. 1-3, a bicycle 10 is illustrated with a pair of shift operating devices (shifters) 12 in accordance with a preferred embodiment of the present invention. Preferably, the left hand side bicycle control device (FIGS. 2 and 3) is substantially identical to the right hand side bicycle control device, except for the shifting unit has been modified to reduce the number of gears that can be shifted. Thus, only one of the shifters 12 will be discussed and illustrated herein. The bicycle 10 basically includes a frame 14 with a handlebar 16 pivotally coupled thereto in a conventional manner. Specifically, the handlebar 16 is fixedly coupled to the front fork of the frame 14 to steer the bicycle 10. The bicycle 10 also has a drive train or transmission 18 that includes a front derailleur 20, a rear derailleur 22, a chain 24, a plurality of rear sprockets 26 and a front crank 28 with a plurality of front sprockets 30 coupled thereto. The front and rear derailleurs 20 and 22 are coupled to the frame 14 to move/shift the chain 24 laterally between the various sprockets 26 and 30 in a relatively conventional manner.

Since most of the parts of the bicycle 10 are well known in the art, the parts of the bicycle 10 will not be discussed or illustrated in detail herein, except for the parts that relate to the present invention. In other words, only the parts related to the bicycle control device 12 will be discussed and illustrated in detail herein. Moreover, various conventional bicycle parts such as brakes, additional sprockets, derailleurs, etc., which are not illustrated and/or discussed in detail herein, can be used in conjunction with the present invention.

The shifter 12 is operated by a shift or control cable 32, which is a conventional bicycle cable that has an outer casing 34 that covers an inner wire 36. The shift cable 32 is coupled to a bicycle cable connection arrangement of the shifter 12 as explained below. Since the present invention is primarily directed to this bicycle cable connection arrangement, the shifter 12 will not be discussed in detail herein. Rather, the shifter 12 that is illustrated herein is disclosed in U.S. Pat. No. 6,694,840 (assigned to Shimano, Inc.), except for the bicycle cable connection arrangement of the present invention.

Still referring to FIGS. 1-3, the shifter 12 will now be discussed in more detail. The shifter 12 basically includes a mounting structure 40, a winding mechanism 42 and an operating mechanism 44. The winding mechanism 42 and the operating mechanism 44 are coupled to the mounting structure 40. The winding mechanism 42 is controlled by the operating mechanism 44 to selectively maintain one of the derailleurs 20 and 22 in one of a plurality of shift positions via the shift cable 32. More specifically, the inner wire 36 of the shift cable 32 is pulled or pushed to operate one of the derailleurs 20 and 22.

The winding mechanism 42 basically includes a wire takeup member 46, a ratchet mechanism 48 with a gear positioning plate 48a and a main biasing member 50. The main biasing member 50 is preferably a torsion spring that normally biases the wire takeup member 46 and the ratchet mechanism 48 in a predetermined rotational direction, e.g., the clockwise direction as seen in FIG. 3. The winding mechanism 42 is operatively coupled to the operating mechanism 44 to selectively retain the wire takeup member 46 in one of a plurality of shift positions.

As seen in FIG. 3, the wire takeup member 46 is rotatably mounted to the mounting structure 40 via a main fixing bolt 52. Thus, the main fixing bolt 52 forms the center pivot axis of the wire takeup member 46 with the wire takeup member 46 being coupled to the mounting structure 40 for rotation about the main fixing bolt 52. In the illustrated embodiment, the wire takeup member 46 is integrally formed as a one-piece unitary member that is attached to the inner wire 36 of the shift cable 32 by a cable end attachment member 54. The wire takeup member 46 and the cable end attachment member 54 form the bicycle cable connection arrangement of the present invention.

As seen in FIGS. 3-6, the wire takeup member 46 basically includes a pivot mounting structure 56 pivotally mounted on the bolt 52 and a cable attachment retaining structure 58 extending radially from the edge of the pivot mounting structure 56. The pivot mounting structure 56 has a central through opening 56a for receiving the bolt 52. The pivot mounting structure 56 of the wire takeup member 46 includes a non-circular projecting portion 60 to fixedly couple the gear positioning plate 48a (FIG. 3) thereto. The projecting portion 60 basically includes a plurality of large splines and a plurality of small splines that are configured to non-rotatably engage the gear positioning plate 48a. The cable attachment retaining structure 58 is offset from the pivot axis of the pivot mounting structure 56 such that the inner wire 36 of the shift cable 32 is pulled or pushed by the rotation of the wire takeup member 46.

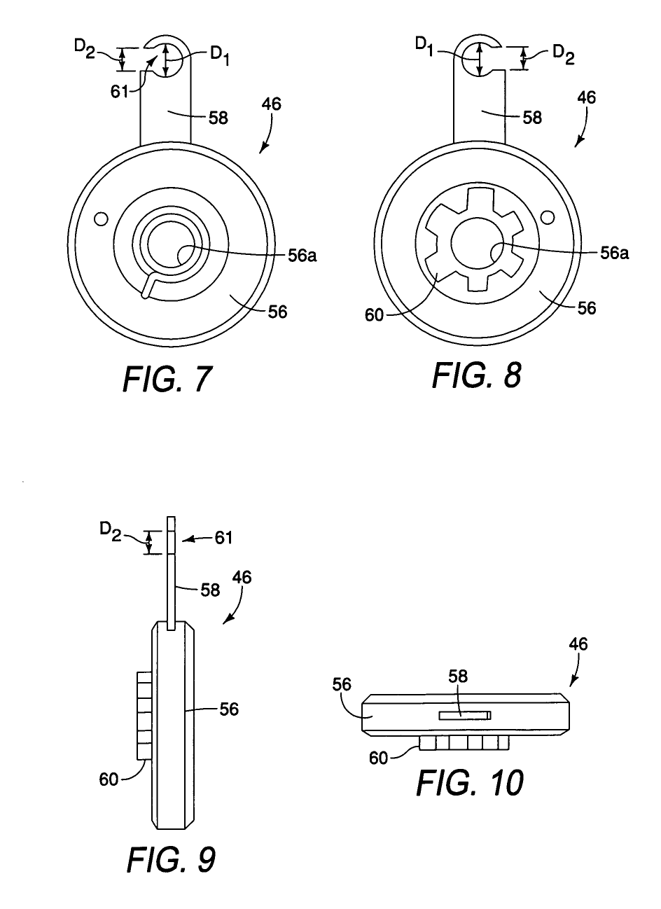

The configuration of the wire takeup member 46 can best be seen in FIGS. 7-10. The cable attachment retaining structure 58 of the wire takeup member 46 is basically a radially extending flange with a retaining slot 61 formed therein. The retaining slot 61 has a retaining portion 61a with a first slot width D₁ and an insertion portion 61b with a second slot width D₂ that is smaller than the first slot width D₁ of the retaining portion 61a. The retaining portion 61a of the retaining slot 61 is at least partially defined by a curved surface that allows the cable end attachment member 54 to rotate within the retaining portion 61a of the retaining slot 61.

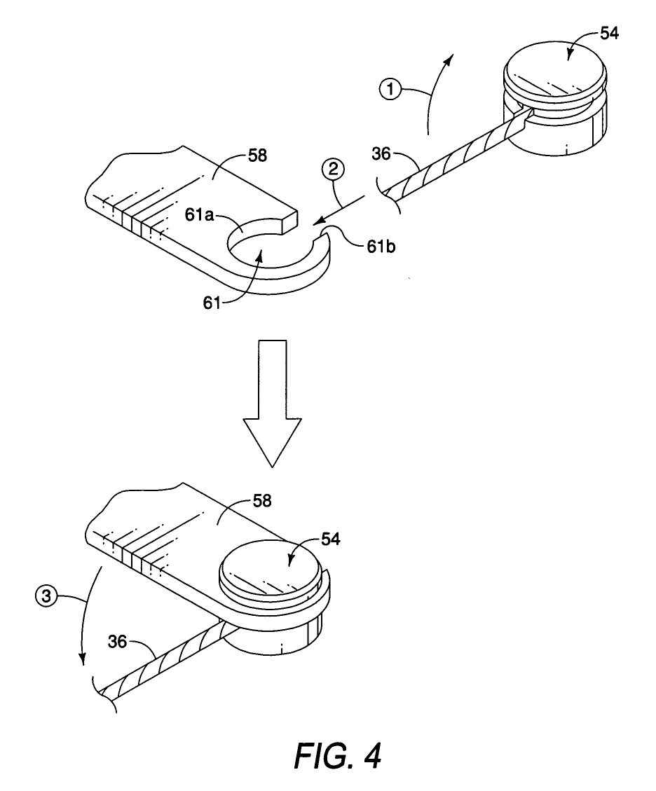

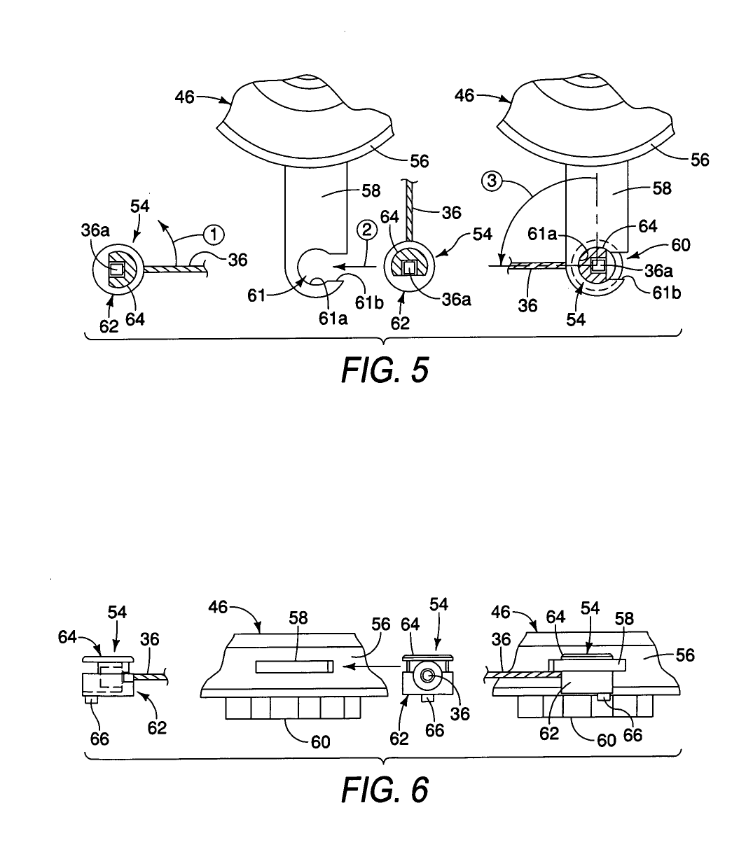

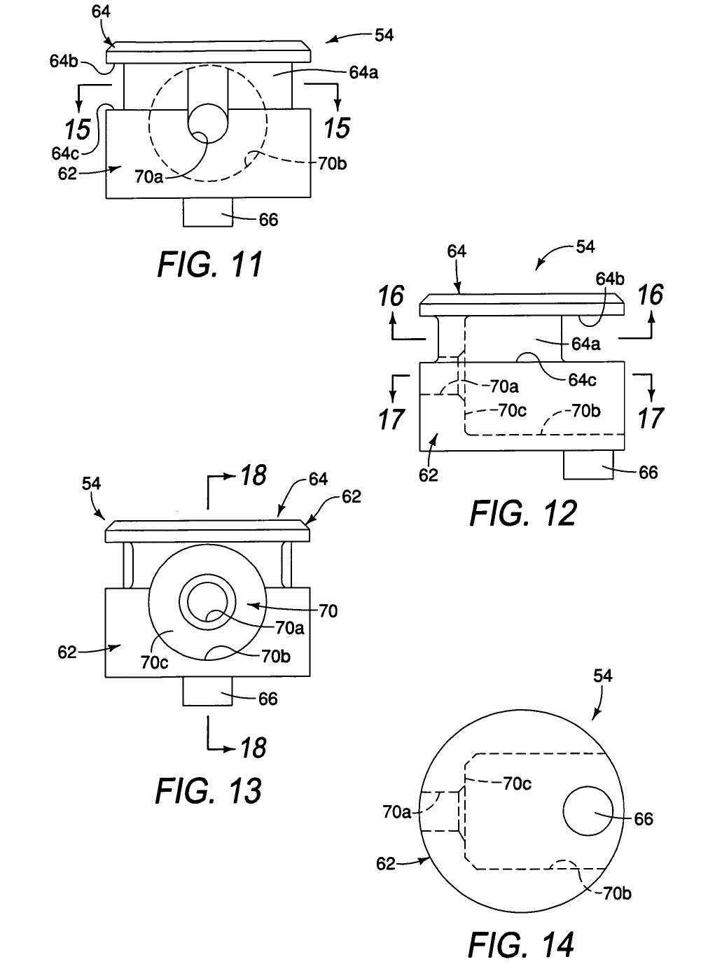

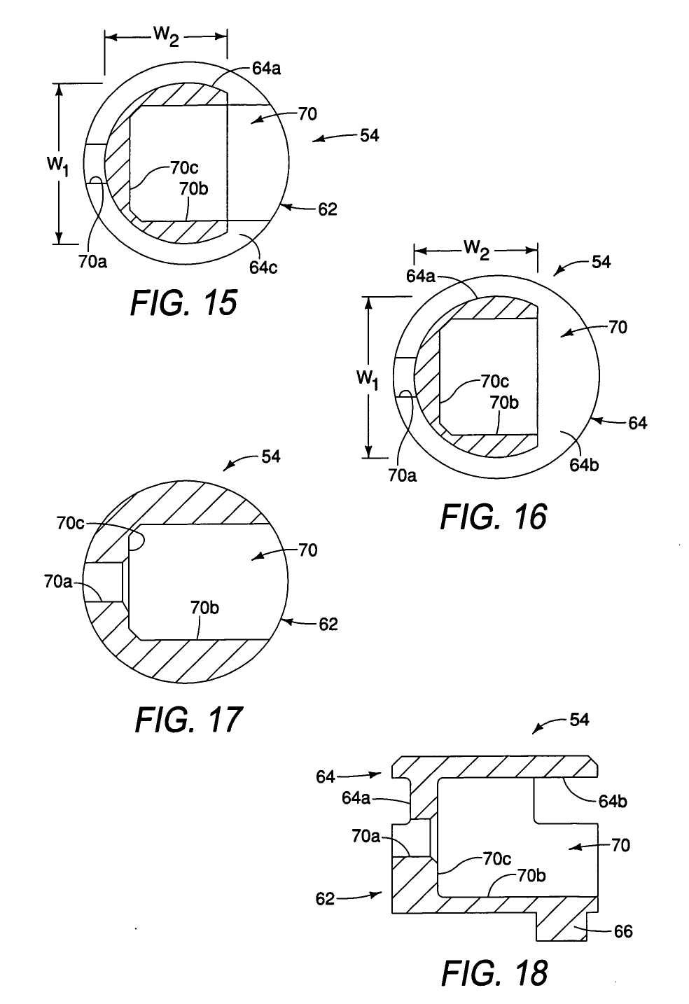

As best seen in FIGS. 11-18, the cable end attachment member 54 basically includes a cable receiving structure 62, a mating mounting structure 64 and a rotating structure 66. In the illustrated embodiment, the cable end attachment member 54 is integrally formed as a one-piece unitary member that is attached to the inner wire 36 of the shift cable 32. The cable end attachment member 54 is installed into the retaining slot 61 of the cable attachment retaining structure 58 of the wire takeup member 46 in basically three steps as indicated by the arrows \textcircled{1}, \textcircled{2}, and \textcircled{3} in FIGS. 4 and 5.

The cable receiving structure 62 includes a step shaped through bore 70 having a first section 70a with a first width and a second section 70b with a second width that is larger than the first width of the first section 70a to form an internal abutment 70c between the first and second sections 70a and 70b. The first and second sections 70a and 70b of the through bore 70 are concentrically arranged. The first width of the first section 70a is preferably slightly larger than the diameter of the inner wire 36 of the shift cable 32 so that the inner wire 36 of the shift cable 32 can be inserted therethrough as seen in FIGS. 5 and 6. The second width of the second section 70b is preferably slightly larger than the diameter of an end nipple 36a of the inner wire 36 of the shift cable 32 so that the end nipple 36a of the inner wire 36 of the shift cable 32 is retained therein as seen in FIGS. 4, 5 and 6.

The mating mounting structure 64 is configured and arranged to be retained in the retaining slot 61 of the cable attachment retaining structure 58 of the wire takeup member 46 in a first orientation and to be releasable from the cable attachment retaining structure 58 of the wire takeup member 46 in a second orientation. In particular, the mating mounting structure 64 is dimensioned so that the mating mounting structure 64 can be inserted through the insertion portion 61b of the retaining slot 61 to the retaining portion 61a of the retaining slot 61 when in the first orientation. Once the mating mounting structure 64 is located in the retaining portion 61a of the retaining slot 61, the cable end attachment member 54 is rotated to the second orientation by using the rotating structure 66 on the bottom of the cable receiving structure 62 as seen in FIGS. 4, 5 and 6.

More particularly, the mating mounting structure 64 of the cable end attachment member 54 includes an engagement portion 64a located between a pair of abutments 64b and 64c. When the engagement portion 64a of the mating mounting structure 64 is located in the retaining slot 61 of the cable attachment retaining structure 58, the abutments 64b and 64c are located on opposite sides of the flange (cable attachment retaining structure) 58 of the wire takeup member 46. The engagement portion 64a has a first engagement width W₁ measured in a first direction and a second engagement width W₂ measured in a second direction with the first engagement width W₁ being larger than the second slot width D₂ and the second engagement width W₂ being smaller than the second slot width D₂. The engagement portion 64a of the mating mounting structure 64 is preferably a partially cylindrical shaft with the first engagement width W₁ being a diameter of the partially cylindrical shaft. Thus, the retaining portion 61a of the retaining slot 61 and the engagement portion 64a of the mating mounting structure 64 are configured and dimensioned such that the engagement portion 64a of the mating mounting structure 64 is rotatably within the retaining portion 61a of the retaining slot 61 between the first and second orientations.

Referring now to back to FIGS. 2 and 3, the operating mechanism 44 basically includes a first operating member 70, a second operating member 72, an operating link 74 and a follower link 76. The first operating member 70 together with the operating link 74, the follower link 76 and the mounting structure 40 form a four-bar linkage that controls movement of the first operating member 70. When the first operating member 70 is pushed, this movement causes the wire takeup member 46 to rotate against the force of the main biasing member 50 to pull the inner wire 36 of the shift cable 32. The second operating member 72 is arranged to selectively release the ratchet mechanism 48 so that the wire takeup member 46 is rotated by the force of the main biasing member 50 to push the inner wire 36 of the shift cable 32. In other words, the rider pushes or moves the second operating member 72 to disengage the ratchet mechanism 48, which allows the wire takeup member 46 to rotate under the urging force of the main biasing member 50.

### General Interpretation of Terms

As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention. Also in understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle cable connection arrangement comprising:
a wire takeup member including a cable attachment retaining structure; and
a cable end attachment member including a cable receiving structure and a mating mounting structure that is configured and arranged to be retained to the cable attachment retaining structure of the wire takeup member in a first orientation and to be releasable from the cable attachment retaining structure of the wire takeup member in a second orientation.

2. The bicycle cable connection arrangement according to claim 1, wherein
the wire takeup member further includes a pivot mounting structure with the cable attachment retaining structure being offset from a pivot axis of the pivot mounting structure.

3. The bicycle cable connection arrangement according to claim 2, wherein
the wire takeup member further includes a gear positioning plate fixedly coupled thereto.

4. The bicycle cable connection arrangement according to claim 1, wherein
the cable attachment retaining structure includes a retaining slot having a retaining portion with a first slot width and an insertion portion with a second slot width that is smaller than the first slot width of the retaining portion; and
the mating mounting structure of the cable end attachment member includes an engagement portion having a first engagement width measured in a first direction and a second engagement width measured in a second direction with the first engagement width being larger than the second slot width and the second engagement width being smaller than the second slot width.

5. The bicycle cable connection arrangement according to claim 4, wherein
the retaining portion of the retaining slot and the engagement portion of the mating mounting structure are configured such that the engagement portion of the mating mounting structure is rotatably within the retaining portion of the retaining slot between the first and second orientations.

6. The bicycle cable connection arrangement according to claim 4, wherein
the engagement portion of the mating mounting structure is a partially cylindrical shaft with the first engagement width being a diameter of the partially cylindrical shaft.

7. The bicycle cable connection arrangement according to claim 6, wherein
the retaining portion of the retaining slot is at least partially defined by a curved surface that corresponds to the partially cylindrical shaft such that the partially cylindrical shaft can rotate within the retaining portion of the retaining slot.

8. The bicycle cable connection arrangement according to claim 1, wherein
the cable receiving structure includes a through bore including a first section with a first width and second section with a second width that is larger than the first width of the first section to form an internal abutment between the first and second sections.

9. The bicycle cable connection arrangement according to claim 8, wherein
the first and second sections of the through bore are concentrically arranged.

10. The bicycle cable connection arrangement according to claim 4, wherein
the cable attachment retaining structure of the wire takeup member includes a flange with the retaining slot formed therein; and
the mating mounting structure of the cable end attachment member further includes a pair of abutments located on opposite sides of the flange of the wire takeup member when the engagement portion of the mating mounting structure is located in the retaining slot.
